(19) United States
(12) Patent Application Publication
(10) Pub. No.: US 2025/0131217 A1
(43) Pub. Date: Apr. 24, 2025

(54) INFORMATION PROCESSING SYSTEM, INFORMATION PROCESSING APPARATUS AND INFORMATION PROCESSING METHOD

(71) Applicant: NEC Corporation, Minato-ku, Tokyo (JP)

(72) Inventor: Jun UCHIMURA, Tokyo (JP)

(73) Assignee: NEC Corporation, Minato-ku, Tokyo (JP)

(21) Appl. No.: 18/695,878

(22) PCT Filed: Oct. 6, 2021
(86) PCT No.: PCT/JP2021/037032

§ 371 Date: Mar. 27, 2024

(51) Int. Cl. G06K 7/10

(52) U.S. Cl. CPC G06K 7/10366

(57) ABSTRACT

An information processing apparatus (10) includes at least one communication apparatus (30) and an information processing apparatus (20). The communication apparatus (30) communicates with an IC tag (42) attached to each of a plurality of objects (40). The information processing apparatus (20) processes first information read from the IC tag (42) by the communication apparatus (30). A person is allowed to bring the object (40) into a confirmation region where the object (40) can be confirmed. Moreover, a communicable region of the communication apparatus (30) overlaps at least a portion of the confirmation region. Then, the information processing apparatus (20) processes the first information, thereby generates bring-in information indicating that the object (40) has been brought into the confirmation region, and causes the bring-in information to be stored in a storage unit.

### TECHNICAL FIELD

The present invention relates to an information processing system, an information processing apparatus, an information processing method, and a program.

### BACKGROUND ART

In recent years, attaching an IC tag to an object and thereby managing the object has been performed. One example of an object is a product displayed in a store, or a book accommodated in a library.

For example, Patent Document 1 describes managing lending, return status, an existence place, or usage frequency and time of a paper medium and an electronic medium by attaching an RFID tag to the paper medium and the electronic medium and placing a communication sheet that communicates with RFID on a shelf of a bookshelf.

Moreover, Patent Document 2 describes that whether a book is on a bookshelf or being read in a reading room can be ascertained, by attaching an IC tag to the book, and installing an IC tag reader between the bookshelf and the reading room.

### RELATED DOCUMENT

### Patent Document

Patent Document 1: Japanese Patent Application Publication No. 2012-003318
Patent Document 2: Japanese Patent Application Publication No. 2009-110323

### SUMMARY OF INVENTION

### Technical Problem

Bringing an object into a confirmation region for confirming the object is performed, as typified by a fitting space for a clothing article or a reading room in a library. In such a case, it is important to manage a bring-in history of an object into the confirmation region. For example, as described in Patent Document 2, even when a communication unit that communicates with an IC tag is installed between a bookshelf and a reading room, it is possible to manage the bring-in history described above. However, a communication unit may not be able to be installed between a bookshelf and a reading room due to a structure of a building or a flow line of a person.

One example of an object of the present invention is to ensure that a bring-in history of an object into a confirmation region can be managed without installing an IC tag reader between storage regions where the object is stored or person regions.

### Solution to Problem

According to one aspect of the present invention, there is provided an information processing system including:
at least one communication unit that communicates with an IC tag attached to each of a plurality of objects movable by a person; and
a determination unit that processes first information read from the IC tag by the communication unit, in which
a person is allowed to bring the object into a confirmation region where the object can be confirmed,
a communicable region of the at least one communication unit overlaps at least a portion of the confirmation region, and
the determination unit processes the first information, thereby generates bring-in information indicating that the object has been brought into the confirmation region, and causes the bring-in information to be stored in a storage unit.

According to one aspect of the present invention, there is provided an information processing apparatus used with
an IC tag attached to each of a plurality of objects movable by a person, and
at least one communication unit that communicates with the IC tag, in which
a person is allowed to bring the object into a confirmation region where the object can be confirmed, and
a communicable region of the at least one communication unit overlaps at least a portion of the confirmation region,
the information processing apparatus including:
an acquisition unit that acquires, from the at least one communication unit, first information read from the IC tag: and
a determination unit that processes the first information, thereby generates bring-in information indicating that the object has been brought into the confirmation region, and causes the bring-in information to be stored in a storage unit.

According to one aspect of the present invention, there is provided an information processing method performed by a computer used with
an IC tag attached to each of a plurality of objects movable by a person, and
at least one communication unit that communicates with the IC tag, in which
a person is allowed to bring the object into a confirmation region where the object can be confirmed, and
a communicable region of the at least one communication unit overlaps at least a portion of the confirmation region,
the information processing method including,
by the computer executing:
   acquisition processing of acquiring, from the at least one communication unit, first information read from the IC tag: and
   determination processing of processing the first information, thereby generating bring-in information indicating that the object has been brought into the confirmation region, and causing the bring-in information to be stored in a storage unit.

According to one aspect of the present invention, there is provided a program executed by a computer used with
an IC tag attached to each of a plurality of objects movable by a person, and
at least one communication unit that communicates with the IC tag, in which
a person is allowed to bring the object into a confirmation region where the object can be confirmed, and
a communicable region of the at least one communication unit overlaps at least a portion of the confirmation region,
the program causing the computer to include:
   an acquisition function of acquiring, from the at least one communication unit, first information read from the IC tag: and
   a determination function of processing the first information, thereby generating bring-in information indicating that the object has been brought into the confirmation region, and causing the bring-in information to be stored in a storage unit.

### Advantageous Effects of Invention

According to one aspect of the present invention, a bring-in history of an object into a confirmation region can be managed without installing an IC tag reader between storage regions where the object is stored or person regions.

### BRIEF DESCRIPTION OF DRAWINGS

The above-described object, other objects, features, and advantageous effects will become more apparent from a preferred example embodiment described below and the following accompanying drawings.

FIG. 1 It is a diagram for describing a configuration of an information processing system according to an example embodiment and a usage environment thereof.

FIG. 2 It is a diagram illustrating one example of a functional structure of an information processing apparatus.

FIG. 3 It is a diagram illustrating one example of information stored in a tag information storage unit when an object is a material of a library.

FIG. 4 is a diagram illustrating one example of information stored in a bring-in information storage unit in the example illustrated in FIG. 3.

FIG. 5 It is a diagram illustrating one example of information stored in a tag information storage unit 50 when an object is a product displayed in a store.

FIG. 6 It is a diagram illustrating one example of information stored in the bring-in information storage unit in the example illustrated in FIG. 5.

FIG. 7 It is a diagram illustrating a hardware configuration example of the information processing apparatus.

FIG. 8 It is a diagram for describing an attachment position of an IC tag when an object is a book.

FIG. 9 It is a flowchart illustrating one example of an operation of the information processing apparatus.

### DESCRIPTION OF EMBODIMENTS

Hereinafter, an example embodiment of the present invention is described by use of the drawings. Note that, in all of the drawings, a similar component is assigned with a similar reference sign, and description thereof will not be repeated as appropriate.

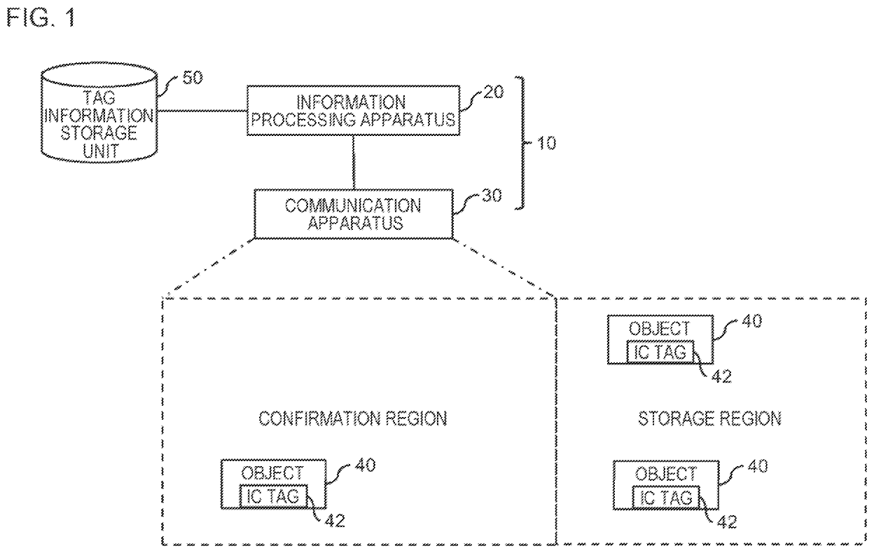

FIG. 1 is a diagram for describing a configuration of an information processing system 10 according to an example embodiment and a usage environment thereof. The information processing system 10 manages movement of an object 40. Specifically, the object 40 is movable by a person. Then, the information processing system 10 manages that the object 40 has been brought into a confirmation region by the person. A confirmation region is a region where a person who has brought in the object 40 is permitted to confirm the object 40.

The object 40 is, for example, a material managed in a storage region, or a product displayed in a store. When the object 40 is a material, one example of a storage region is an open-shelf region in a library, one example of the object 40 is a material such as a book, or a storage medium such as a CD, and one example of a confirmation region is a reading space. When the object 40 is a product, a storage region is a region where the product is displayed, one example of the object 40 is a clothing article, and one example of a confirmation region is a region, such as a fitting space, where trial use of a product is permitted.

An IC tag 42 is attached to each of a plurality of the objects 40. One example of the IC tag 42 is an RFID tag, but the IC tag 42 is not limited thereto. The IC tag 42 stores identification information unique to the IC tag 42. Hereinafter, the identification information is referred to as tag identification information.

Tag identification information is stored in a tag information storage unit 50 in association with detailed information of an object to which the IC tag 42 relevant to the tag identification information is attached. Detailed information when an object is a material, is, for example, a name and a producer or an author of the material, and may further include a publication date and an international standard book number (ISBN) code. Detailed information when an object is a clothing article is, for example, a category, a model number, and a size of the clothing article, but may further include a color. In the example illustrated in the present figure, the tag information storage unit 50 recovers outside the information processing apparatus 20, but may be incorporated in the information processing apparatus 20.

The information processing system 10 includes the information processing apparatus 20 and a communication apparatus 30. The communication apparatus 30 communicates with the IC tag 42 located in a communicable region. The number of the communication apparatuses 30 may be one or plural. Then, a communicable region of the communication apparatus 30 overlaps at least a portion of the confirmation region. Preferably, the communicable region of the communication apparatus 30 preferably overlaps the entire confirmation region.

As one example, when a confirmation region is a reading space in a library, at least one desk and at least one chair are generally arranged in the reading space. Then, a confirmable range of the communication apparatus 30 includes at least part, preferably an entirety of a region occupied by the desk and the chair arranged in the reading space. For such a purpose, at least one communication apparatus 30 may be arranged on at least one of a side, information, and a floor of the confirmation region. As one example, the communication apparatus 30 may be embedded in a wall of a confirmation region, or may be arranged along the wall. Moreover, the communication apparatus 30 may be fixed to a ceiling of a confirmation region, or may be embedded in the ceiling. Moreover, the communication apparatus 30 may be arranged on a floor of a confirmation region, for example, under a desk. In this case, the communication apparatus 30 may be sheet-shaped.

The communication apparatus 30 repeatedly attempts communication with the IC tag 42 regardless of presence or absence of the IC tag 42. An interval of the communication is, for example, equal to or more than one second and equal to or less than five minutes. Then, when a person brings the object 40 into a confirmation region, the communication apparatus 30 communicates with the IC tag 42 attached to the object 40, and thereby reads first information stored in the IC tag 42. The first information includes at least tag identification information. The information processing apparatus 20 generates bring-in information by processing the first information read by the communication apparatus 30. The bring-in information indicates that the object has been brought into the confirmation region. The information processing apparatus 20 manages, by use of the bring-in information, a history of the object brought into the confirmation region.

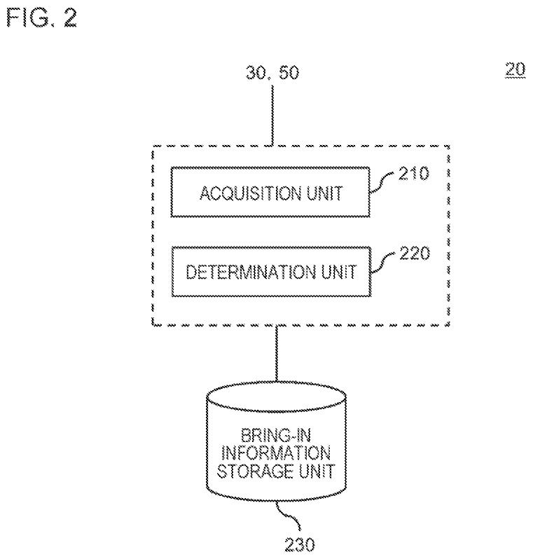

FIG. 2 is a diagram illustrating one example of a functional configuration of the information processing apparatus 20. The information processing apparatus 20 includes an acquisition unit 210 and a determination unit 220.

The acquisition unit 210 acquires first information from the communication apparatus 30. The first information is information read from the IC tag 42 by the communication apparatus 30, as described above.

The determination unit 220 generates the above-described bring-in information by processing the first information acquired by the acquisition unit 210. Moreover, the determination unit 220 causes the generated bring-in information to be stored in the bring-in information storage unit 230.

Then, a user of the information processing system 10 can check a history of the object brought into the confirmation region, by checking the bring-in information stored in the bring-in information storage unit 230.

In the example illustrated in the present figure, the bring-in information storage unit 230 is a portion of the information processing apparatus 20. However, the bring-in information storage unit 230 may be located outside the information processing apparatus 20.

In the example illustrated in the present figure, it is assumed that the first information includes tag identification information, but does not include another piece of information relating to an object. Thus, the determination unit 220 may read information relevant to the tag identification information from the tag information storage unit 50, and include the read information in the bring-in information. Hereinafter, an example of information stored in the tag information storage unit 50 and information stored in the determination unit 220 is described by use of another figure.

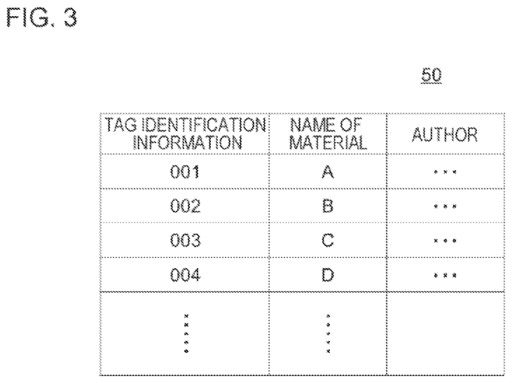

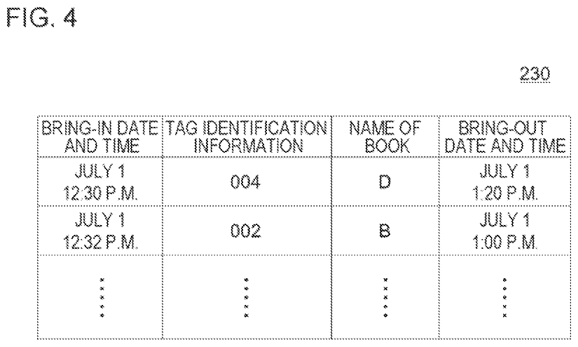

FIG. 3 is a diagram illustrating one example of information stored in the tag information storage unit 50 when an object is a material of a library, such as a book or a storage medium. FIG. 4 is a diagram illustrating one example of information stored in the bring-in information storage unit 230 in this case.

As illustrated in FIG. 3, the tag information storage unit 50 stores, for each of a plurality of materials, tag identification information and detailed information of the material. One example of the detailed information is a name of the material and a producer or an author, as described above, but may further include a publication date and an ISBN code.

Then, as illustrated in FIG. 4, the bring-in information storage unit 230 stores, as bring-in information, a date and time when a material is brought into a confirmation region, tag identification information, at least a portion of detailed information of the material, and a date and time when the material is brought out from the confirmation region. Herein, the date and time when the material is brought into the confirmation region is a timing when first information of the IC tag 42 attached to the material is initially read, and the date and time when the material is brought out from the confirmation region is a timing when the first information of the IC tag 42 is no longer read. However, the bring-in information storage unit 230 may not store the date and time when the material is brought out from the confirmation region.

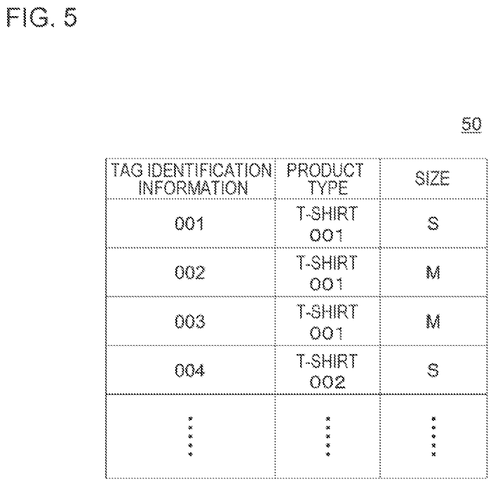

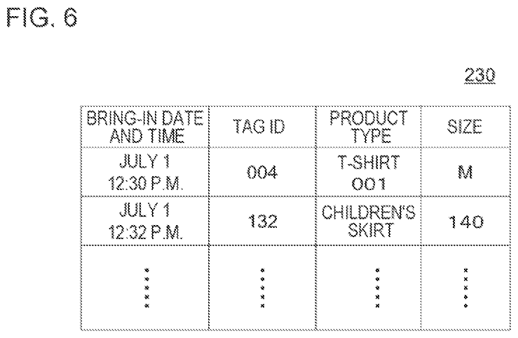

FIG. 5 is a diagram illustrating one example of information stored in the tag information storage unit 50 when an object is a product displayed in a store, such as clothing. FIG. 6 is a diagram illustrating one example of information stored in the bring-in information storage unit 230 in this case.

As illustrated in FIG. 5, the tag information storage unit 50 stores, for each of a plurality of products, tag identification information and detailed information of the product. When a product is a clothing article, one example of detailed information thereof is a category, a model number, and a size of the clothing article, as described above, but may further include a color. Herein, the IC tag 42 is attached to each product. Thus, when a plurality of identical products are displayed, the same information may be stored in a plurality of IC tags 42.

Then, as illustrated in FIG. 6, the bring-in information storage unit 230 is, as bring-in information, a date and time when a product is brought into a confirmation region, tag identification information, and at least a portion of detailed information of the product.

Note that, in the example illustrated in FIGS. 4 and 6, the bring-in information storage unit 230 may not store detailed information of a material. In this case, the information processing apparatus 20 may read, at a timing of reading bring-in information from the bring-in information storage unit 230 and outputting the bring-in information, detailed information relevant to the bring-in information from the tag information storage unit 50, and output the detailed information together with the bring-in information.

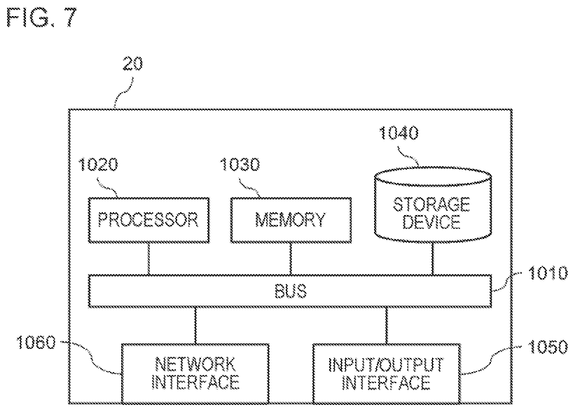

FIG. 7 is a diagram illustrating a hardware configuration example of the information processing apparatus 20. The information processing apparatus 20 includes a bus 1010, a processor 1020, a memory 1030, a storage device 1040, an input/output interface 1050, and a network interface 1060.

The bus 1010 is a data transmission path through which the processor 1020, the memory 1030, the storage device 1040, the input/output interface 1050, and the network interface 1060 transmit/receive data to/from one another. However, a method of mutually connecting the processor 1020 and the like is not limited to bus connection.

The processor 1020 is a processor achieved by a central processing unit (CPU), a graphics processing unit (GPU), or the like.

The memory 1030 is a main storage apparatus achieved by a random access memory (RAM) or the like.

The storage device 1040 is an auxiliary storage apparatus achieved by a hard disk drive (HDD), a solid state drive (SSD), a removable medium such as a memory card, a read only memory (ROM), or the like. The storage device 1040 stores a program module that achieves each function (e.g., the acquisition unit 210 and the determination unit 220) of the information processing apparatus 20. The processor 1020 reads each of the program modules onto the memory 1030, executes the read program module, and thereby achieves each function relevant to the program module. Moreover, the storage device 1040 also functions as the bring-in information storage unit 230.

The input/output interface 1050 is an interface for connecting the information processing apparatus 20 to various kinds of input/output equipment.

The network interface 1060 is an interface for connecting the information processing apparatus 20 to a network. The network is, for example, a local area network (LAN) or a wide area network (WAN). A method of connecting the network interface 1060 to the network may be wireless connection, or may be wired connection. The information processing apparatus 20 may communicate with the communication apparatus 30 and the tag information storage unit 50 via the network interface 1060.

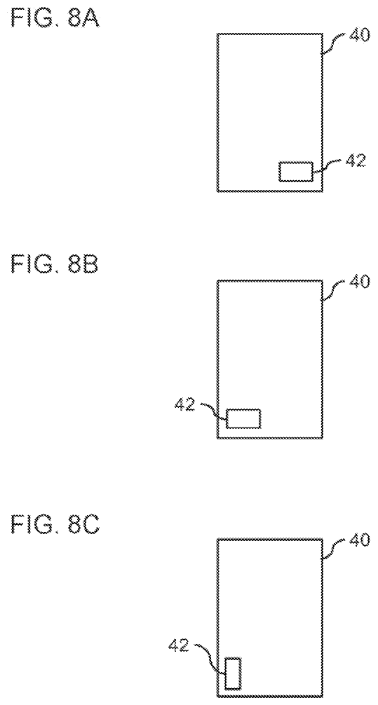

FIG. 8 is a diagram for describing an attachment position of the IC tag 42 when the object 40 is a book. The IC tag 42 is attached to a front cover or a back cover of the object 40. Then, an attachment position of the IC tag 42 in at least one object 40 differs from an attachment position of the IC tag 42 in another of the objects 40.

For example, as can be seen by comparing FIGS. 8(A) and 8(B), among four sides of the object 40, the sides closest to the IC tag 42 are identical to each other, but positions of the IC tag 42 in a direction along the side may differ from each other. Moreover, as can be seen by comparing FIGS. 8(A) and 8(C), the sides closest to the IC tag 42 may differ from each other.

A planar shape of a book often follows a previously determined standard. Moreover, when the same person simultaneously brings a plurality of books into a confirmation region, the person often stacks the plurality of books on the desk. Thus, in a case where the communication apparatus 30 is located above or below the desk, and an attachment position of the IC tags 42 is the same among a plurality of the objects 40, there arises a possibility that a plurality of the IC tags 42 overlap with each other when viewed from the communication apparatus 30. In this case, the communication apparatus 30 may not be able to acquire the first information from any of the IC tags 42.

Contrarily, when attachment positions of the IC tags 42 differ for at least two of the objects 40 as in the present example embodiment, a possibility that a plurality of IC tags 42 overlap lowers.

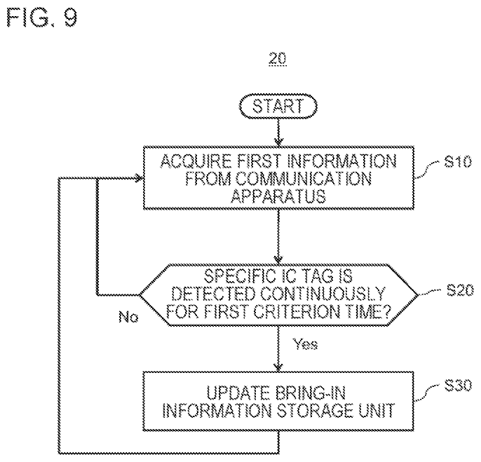

FIG. 9 is a flowchart illustrating one example of an operation of the information processing apparatus 20. As described by use of FIG. 1, the communication apparatus 30 repeatedly attempts communication with the IC tag 42. Then, when a person brings the object 40 into a confirmation region, the communication apparatus 30 acquires first information from the IC tag 42 attached to the object 40. The acquisition unit 210 of the information processing apparatus 20 acquires the first information from the communication apparatus 30 (step S10).

Then, the determination unit 220 determines whether tag identification information included in currently acquired first information is acquired continuously for a first criterion time (step S20). When the tag identification information is acquired continuously for the first criterion time (step S20: Yes), the determination unit 220 determines that the object 40 relevant to the tag identification information is brought into the confirmation region, generates bring-in information, and updates the bring-in information storage unit 230 (step S30). In this way, even when the communication apparatus 30 temporarily senses the IC tag 42 located outside the confirmation region, a possibility that the determination unit 220 determines that the object 40 relevant to the IC tag 42 is brought into the object 40 lowers.

A detailed example of step S20 is described below. When new tag identification information is included in currently acquired first information, the determination unit 220 stores the tag identification information in a database together with a time at which the first information is acquired, i.e., a reading start time. The database is stored, for example, in the bring-in information storage unit 230, but may be stored in another storage unit.

On the other hand, when tag identification information included in currently acquired first information is stored in the database, the determination unit 220 reads a reading start time relevant to the tag identification information from the database, and computes a difference between the reading start time and a current time. Then, when the difference is equal to or more than the first criterion time, the determination unit 220 determines that the tag identification information included in the currently acquired first information is acquired continuously for equal to or more than the first criterion time. Then, the determination unit 220 determines the reading start time as a date and time when the object 40 is brought into a confirmation region.

On the other hand, when the difference is less than a first criterion time, the determination unit 220 stores the time when the first information is currently acquired, in a database as a latest reading time. Note that, when the latest reading time is already stored in the database, the determination unit 220 updates the latest reading time to a current time.

Moreover, when the tag identification information stored in the database has not been detected continuously for equal to or more than a second criterion time, the determination unit 220 determines that the object 40 relevant to the tag identification information is brought out from the confirmation region. The second criterion time may be longer than, shorter than, or the same as the first criterion time. Then, the determination unit 220 determines a latest reading time as a date and time when the object 40 is brought out from the confirmation region.

Thereafter, a user of the information processing apparatus 20 processes the information stored in the bring-in information storage unit 230 by use of, for example, the information processing apparatus 20, and counts the number of times each object 40 is brought into the confirmation region. Thereby, the user can determine the object 40 with high usage frequency. Moreover, when the bring-in information storage unit 230 stores both a date and time when the object 40 is brought into the confirmation region and a date and time when the object 40 is brought out from a bad person region, the user can recognize a usage time in the confirmation region for each of the objects 40.

As described above, according to the present example embodiment, when the object 40 is brought into the confirmation region, the information processing apparatus 20 generates bring-in information indicating the fact, and stores the bring-in information in the bring-in information storage unit 230. Thus, the user of the information processing apparatus 20 can check a history of the object 40 brought into the confirmation region, by checking the bring-in information storage unit 230. Moreover, it is not necessary to install the communication apparatus 30 between a storage region and a confirmation region between a bookshelf and a reading room.

The example embodiments according to the present invention have been described above with reference to the drawings, but are exemplifications of the present invention, and various configurations other than those described above can be adopted.

Moreover, although a plurality of steps (pieces of processing) are described in order in a plurality of flowcharts used in the above description, an execution order of steps executed in each example embodiment is not limited to the described order. In each example embodiment, an order of illustrated steps can be changed to an extent that causes no problem in terms of content. Moreover, each of the example embodiments described above can be combined to an extent that content does not contradict.

Some or all of the above-described example embodiments can also be described as, but are not limited to, the following supplementary notes.
1. An information processing system including:
   at least one communication unit that communicates with an IC tag attached to each of a plurality of objects movable by a person: and
   a determination unit that processes first information read from the IC tag by the communication unit, in which
   a person is allowed to bring the object into a confirmation region where the object can be confirmed,
   a communicable region of the at least one communication unit overlaps at least a portion of the confirmation region, and
   the determination unit processes the first information, thereby generates bring-in information indicating that the object has been brought into the confirmation region, and causes the bring-in information to be stored in a storage unit.
2. The information processing system according to supplementary note 1, in which
   the object is a material managed in a storage region.
3. The information processing system according to supplementary note 2, in which
   at least one desk and at least one chair are arranged in the confirmation region, and
   the communicable region includes at least a portion of a region occupied by the at least one desk and the at least one chair.
4. The information processing system according to supplementary note 3, in which
   the communicable region includes an entirety of a region occupied by the at least one desk and the at least one chair.
5. The information processing system according to any one of supplementary notes 2 to 4, in which
   the at least one communication unit is located above the confirmation region or on a floor of the confirmation region,
   at least some of a plurality of the materials are books,
   the IC tag is further provided,
   the IC tag is attached to a front cover or a back cover of the book, and
   an attachment position of the IC tag in at least one of the books differs from an attachment position of the IC tag in another of the books.
6. The information processing system according to supplementary note 1, in which
   the object is a product displayed in a store.
7. The information processing system according to supplementary note 6, in which
   the confirmation region is a region where trial use of the product is permitted.
8. The information processing system according to any one of supplementary notes 1 to 7, in which
   the determination unit generates the bring-in information of the object to which the IC tag is attached, when information is read from the IC tag continuously for equal to or more than a criterion time.
9. An information processing apparatus used with
   an IC tag attached to each of a plurality of objects movable by a person, and
   at least one communication unit that communicates with the IC tag, in which
   a person is allowed to bring the object into a confirmation region where the object can be confirmed, and
   a communicable region of the at least one communication unit overlaps at least a portion of the confirmation region,
   the information processing apparatus including:
   an acquisition unit that acquires, from the at least one communication unit, first information read from the IC tag: and
   a determination unit that processes the first information, thereby generates bring-in information indicating that the object has been brought into the confirmation region, and causes the bring-in information to be stored in a storage unit.
10. An information processing method performed by a computer used with
   an IC tag attached to each of a plurality of objects movable by a person, and
   at least one communication unit that communicates with the IC tag, in which
   a person is allowed to bring the object into a confirmation region where the object can be confirmed, and
   a communicable region of the at least one communication unit overlaps at least a portion of the confirmation region,
   the information processing method including,
   by the computer executing:
      acquisition processing of acquiring, from the at least one communication unit, first information read from the IC tag: and
      determination processing of processing the first information, thereby generating bring-in information indicating that the object has been brought into the confirmation region, and causing the bring-in information to be stored in a storage unit.
11. The information processing method according to supplementary note 10, in which
   the object is a material managed in a storage region.
12. The information processing method according to supplementary note 11, in which
   at least one desk and at least one chair are arranged in the confirmation region, and
   the communicable region includes at least a portion of a region occupied by the at least one desk and the at least one chair.
13. The information processing method according to supplementary note 12, in which
   the communicable region includes an entirety of a region occupied by the at least one desk and the at least one chair.
14. The information processing method according to any one of supplementary notes 11 to 13, in which
   the at least one communication unit is located above the confirmation region or on a floor of the confirmation region,
   at least some of a plurality of the materials are books,
   the IC tag is attached to a front cover or a back cover of the book, and
   an attachment position of the IC tag in at least one of the books differs from an attachment position of the IC tag in another of the books.
15. The information processing method according to supplementary note 10, in which
   the object is a product displayed in a store.
16. The information processing method according to supplementary note 15, in which
   the confirmation region is a region where trial use of the product is permitted.
17. The information processing method according to any one of supplementary notes 10 to 16, further including,
   in the determination processing, by the computer, generating the bring-in information of the object to which the IC tag is attached, when information is read from the IC tag continuously for equal to or more than a criterion time.
18. A program executed by a computer used with
   an IC tag attached to each of a plurality of objects movable by a person, and
   at least one communication unit that communicates with the IC tag, in which
   a person is allowed to bring the object into a confirmation region where the object can be confirmed, and
   a communicable region of the at least one communication unit overlaps at least a portion of the confirmation region,
   the program causing the computer to include:
      an acquisition function of acquiring, from the at least one communication unit, first information read from the IC tag: and
      a determination function of processing the first information, thereby generating bring-in information indicating that the object has been brought into the confirmation region, and causing the bring-in information to be stored in a storage unit.
19. The program according to supplementary note 18, in which
   the object is a material managed in a storage region.
20. The program according to supplementary note 19, in which
   at least one desk and at least one chair are arranged in the confirmation region, and
   the communicable region includes at least a portion of a region occupied by the at least one desk and the at least one chair.
21. The program according to supplementary note 20, in which
   the communicable region includes an entirety of a region occupied by the at least one desk and the at least one chair.
22. The program according to any one of supplementary notes 19 to 21, in which
   the at least one communication unit is located above the confirmation region or on a floor of the confirmation region,
   at least some of a plurality of the materials are books,
   the IC tag is further provided,
   the IC tag is attached to a front cover or a back cover of the book, and
   an attachment position of the IC tag in at least one of the books differs from an attachment position of the IC tag in another of the books.
23. The program according to supplementary note 18, in which
   the object is a product displayed in a store.
24. The program according to supplementary note 23, in which
   the confirmation region is a region where trial use of the product is permitted.
25. The program according to any one of supplementary notes 19 to 24, in which
   the determination unit generates the bring-in information of the object to which the IC tag is attached, when information is read from the IC tag continuously for equal to or more than a criterion time.

### REFERENCE SIGNS LIST

10 Information processing system
20 Information processing apparatus
30 Communication apparatus
40 Object
42 IC tag
50 Tag information storage unit
210 Acquisition unit
220 Determination unit
230 Bring-in information storage unit

What is claimed is:

1. An information processing system comprising:
at least one tag reader that communicates with an IC tag attached to each of a plurality of objects movable by a person;
at least one memory configured to store instructions; and
at least one processor configured to execute the instructions to perform operations comprising
processing first information read from the IC tag by the tag reader, wherein
a person is allowed to bring the object into a confirmation region where the object can be confirmed,
a communicable region of the at least one tag reader overlaps at least a portion of the confirmation region, and
the operations comprise processing the first information, thereby generating bring-in information indicating that the object has been brought into the confirmation region, and causing the bring-in information to be stored in a storage.

2. The information processing system according to claim 1, wherein
the object is a material managed in a storage region.

3. The information processing system according to claim 2, wherein
at least one desk and at least one chair are arranged in the confirmation region, and
the communicable region includes at least a portion of a region occupied by the at least one desk and the at least one chair.

4. The information processing system according to claim 3, wherein the communicable region includes an entirety of a region occupied by the at least one desk and the at least one chair.

5. The information processing system according to any one of claims 2 to 4, claim 2, wherein
the at least one tag reader is located above the confirmation region or on a floor of the confirmation region,
at least some of a plurality of the materials are books,
the IC tag is further provided,
the IC tag is attached to a front cover or a back cover of the book, and
an attachment position of the IC tag in at least one of the books differs from an attachment position of the IC tag in another of the books.

6. The information processing system according to claim 1, wherein
the object is a product displayed in a store.

7. The information processing system according to claim 6, wherein
the confirmation region is a region where trial use of the product is permitted.

8. The information processing system according to claim 1, wherein
the operations comprise generating the bring-in information of the object to which the IC tag is attached, when information is read from the IC tag continuously for equal to or more than a criterion time.

9. An information processing apparatus used with
an IC tag attached to each of a plurality of objects movable by a person, and
at least one tag reader that communicates with the IC tag, wherein
a person is allowed to bring the object into a confirmation region where the object can be confirmed, and
a communicable region of the at least one tag reader overlaps at least a portion of the confirmation region,
the information processing apparatus comprising:
at least one memory configured to store instructions; and
at least one processor configured to execute the instructions to perform operations comprising:
acquiring, from unit, the at least one tag reader, first information read from the IC tag; and
processing the first information, thereby generating bring-in information indicating that the object has been brought into the confirmation region, and causing the bring-in information to be stored in a storage.

10. An information processing method performed by a computer used with
an IC tag attached to each of a plurality of objects movable by a person, and
at least tag reader that communicates with the IC tag, wherein
a person is allowed to bring the object into a confirmation region where the object can be confirmed, and
a communicable region of the at least one tag reader overlaps at least a portion of the confirmation region,
the information processing method comprising,
by the computer executing:
acquisition processing of acquiring, from the at least one tag reader, first information read from the IC tag; and
determination processing of processing the first information, thereby generating bring-in information indicating that the object has been brought into the confirmation region, and causing the bring-in information to be stored in a storage.

11. (canceled)
